(19) United States
(12) Patent Application Publication
(10) Pub. No.: US 2006/0286013 A1
(43) Pub. Date: Dec. 21, 2006

(54) Engine exhaust system component having structure for accessing aftertreatment device

(76) Inventors: Allan T. Hovda, Savage, MN (US); John I. Belisle, Hampton, MN (US); Kenneth G. Misgen, Prior Lake, MN (US); Robert L. Dahlstrom, Cottage Grove, MN (US); Gary D. Reeves, Lakeville, MN (US); Matthew P. Fortuna, Eagan, MN (US)

Correspondence Address: MERCHANT & GOULD PC, P.O. BOX 2903, MINNEAPOLIS, MN, 55402-0903, US

(21) Appl. No.: 11/411,974

(22) Filed: Apr. 26, 2006

Related U.S. Application Data
(60) Provisional application No. 60/675,698, filed on Apr. 27, 2005.

(51) Int. Cl. B01D 50/00; B01D 53/34

(52) U.S. Cl. 422/177

(57) ABSTRACT

The present disclosure relates to an exhaust system component including a body defining a side access opening, and an aftertreatment device that mounts within the body. The aftertreatment device is removable from the body through the side access opening. The exhaust system component also includes a removable panel that covers the side access opening.

### CROSS REFERENCE TO RELATED APPLICATION

This application claims the benefit of U.S. Provisional Patent Application Ser. No. 60/675,698, filed Apr. 27, 2005, which application is hereby incorporated by reference in its entirety.

### TECHNICAL FIELD

The present invention relates generally to exhaust system components for housing engine exhaust aftertreatment devices having cores such as catalytic converters or diesel particulate filters.

### BACKGROUND

To reduce air pollution, engine exhaust emissions standards have become increasingly more stringent. Aftertreatment devices have been developed to satisfy these increasingly stringent standards. For example, catalytic converters have been used to reduce the concentration of pollutant gases (e.g., hydrocarbons, carbon monoxide, nitric oxide, etc.) exhausted by engines. U.S. Pat. No. 5,355,973, which is hereby incorporated by reference, discloses an example catalytic converter. With respect to diesel engines, diesel particulate filters have been used to reduce the concentration of particulate matter (e.g., soot) in the exhaust stream. U.S. Pat. No. 4,851,015, which is hereby incorporated by reference, discloses an example diesel particulate filter. Other example types of aftertreatment devices include lean NOx catalyst devices, selective catalytic reduction (SCR) catalyst devices, lean NOx traps, or other device for removing for removing pollutants from engine exhaust streams.

At times, it is recommended to service or replace aftertreatment devices. To facilitate servicing and/or replacement, aftertreatment devices are often clamped into an exhaust system as separate units. For example, clamps can be provided at flange interfaces located adjacent opposite ends of the aftertreatment devices. By removing the end clamps, a given aftertreatment device can be removed from its corresponding exhaust system for servicing or replacement.

### SUMMARY

One aspect of the present disclosure relates to an exhaust system component having a construction that facilitates accessing an aftertreatment device housed within the component. In one embodiment, the exhaust system component includes a removable side panel.

Examples representative of a variety of inventive aspects are set forth in the description that follows. The inventive aspects relate to individual features as well as combinations of features. It is to be understood that both the forgoing general description and the following detailed description merely provide examples of how the inventive aspects may be put into practice, and are not intended to limit the broad spirit and scope of the inventive aspects.

### BRIEF DESCRIPTION OF THE DRAWINGS

FIG. 1 is a cross-sectional view of an exhaust system component in accordance with the principles of the present disclosure;

FIG. 2 is an exploded front side, partial cross-sectional view of the exhaust system component of FIG. 1;

FIG. 3 is a top side view of the main body of the exhaust system component of FIG. 1;

FIG. 4 is a perspective view of the cover panel of the exhaust system component of FIG. 1;

FIG. 5 is an end view of the cover panel of FIG. 4;

FIG. 6 is a front side view of the cover panel of FIG. 4;

FIG. 7 is a top side view of the cover panel of FIG. 4;

FIG. 8 is a top side view of another exhaust system component in accordance with the principles of the present disclosure, a can of an aftertreatment device positioned within a housing of the component is shown partially broken away and the clamps are also partially broken away;

FIG. 9 is a front side view of the exhaust system component of FIG. 8 with clamps shown mounted thereon;

FIG. 10 is a cross-sectional view taken along section line 10-10 of FIG. 9;

FIG. 11 is an end view of the exhaust system component of FIG. 8;

FIG. 12 is an enlarged, detailed view of a portion of FIG. 10;

FIG. 13 is a top side view of the housing of the exhaust system component of FIG. 8;

FIG. 14 is a perspective view of a cover panel for the exhaust system component of FIG. 8;

FIG. 15 is a front side view of the cover panel of FIG. 14;

FIG. 16 is an end view of the cover panel of FIG. 14; and

FIG. 17 is a top side view of the cover panel of FIG. 14.

### DETAILED DESCRIPTION

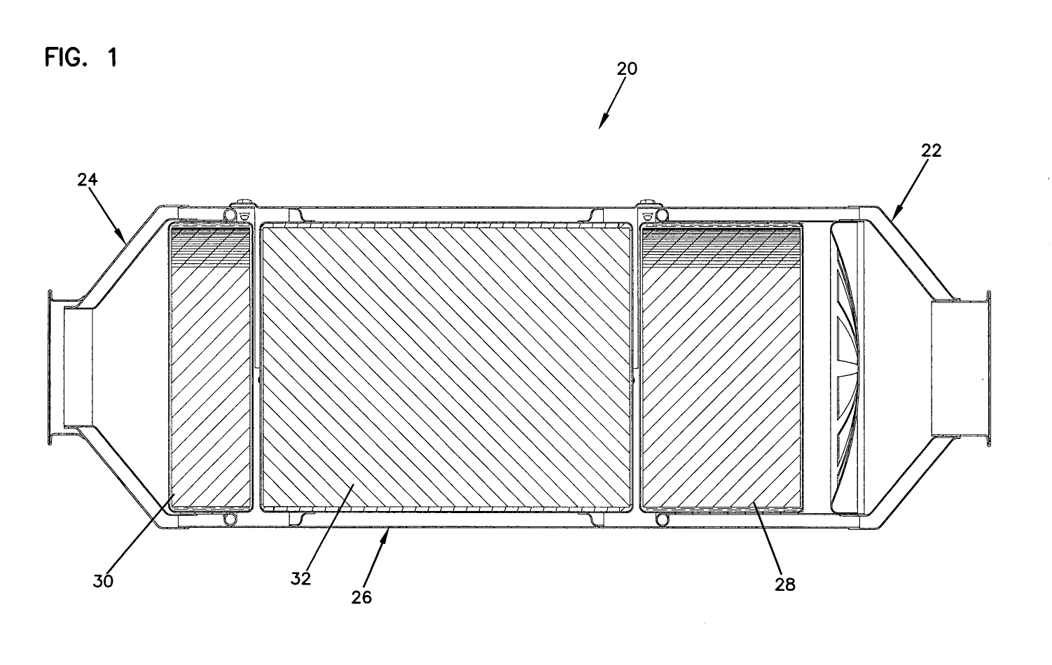

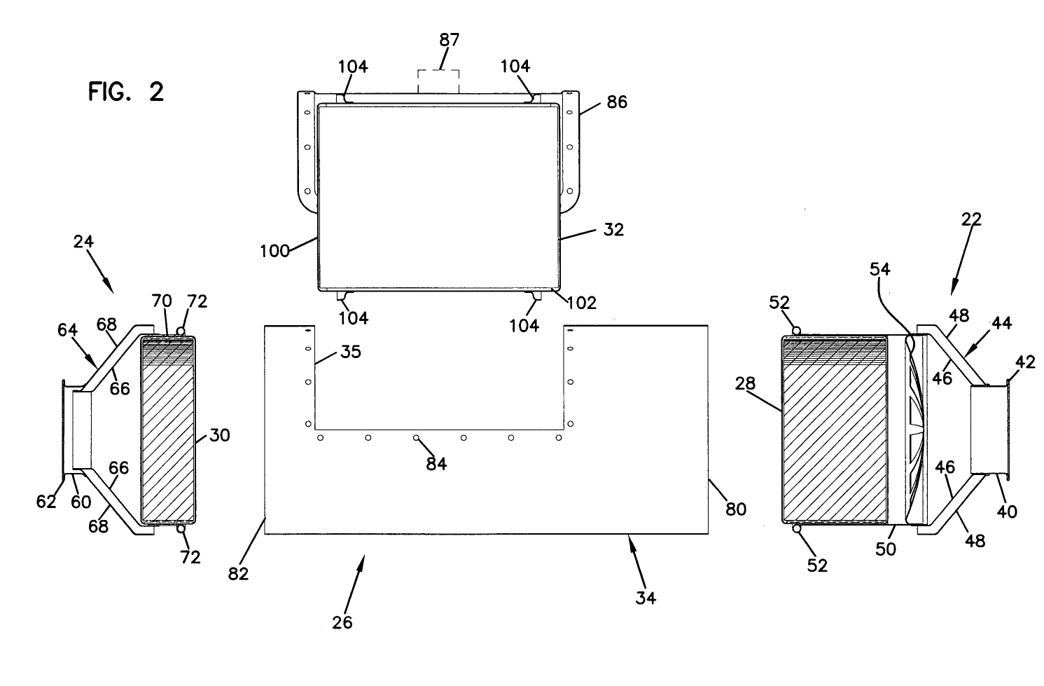

FIG. 1 illustrates an exhaust system component 20 (e.g., a muffler unit) in accordance with the principles of the present disclosure. The exhaust system component includes an inlet section 22, an outlet section 24 and a mid-section 26. Aftertreatment devices 28, 30 (e.g., catalytic converters/diesel oxidation catalysts) are respectively mounted adjacent the inlet section 22 and the outlet section 24. Another aftertreatment device 32 (e.g., a diesel particulate filter) is mounted at the mid-section 26. As shown at FIG. 2, the mid-section 26 includes a main body 34 defining a side access opening 35 for allowing the aftertreatment device 32 to be radially (e.g., in a direction generally transverse to the longitudinal axis of the main body 34) inserted into or removed from the main body 34. The side access opening eliminates the need for the aftertreatment device to be inserted axially into the body 34 through the end of the body 34. In this way, the aftertreatment device can be accessed for servicing without requiring the inlet or outlet sections 22, 24 to be disconnected from the main body 34.

Referring to FIG. 2, the inlet section 22 of the component 20 includes an inlet piece 40 having a flanged end 42 adapted for connection to an inlet pipe. A diameter expander 44 is secured (e.g., welded or otherwise fastened, connected, joined, or integral with) to the inlet piece 40. The diameter expander 44 has a double wall construction including an inner wall 46 spaced from an outer wall 48. A cylindrical wall extension 50 is secured to the inner wall 46 of the diameter expander 44. One end of the wall extension 50 is rolled back to form an annular spacer 52. The aftertreatment device 28 is mounted within the wall extension 50. A flow-distributing baffle 54 is also mounted within the wall extension 50 at a location upstream from the aftertreatment device 28.

Referring still to FIG. 2, the outlet section 24 of the component 20 includes an outlet piece 60 having a flanged end 62 adapted for connection to an outlet pipe. A diameter reducer 64 is secured to the outlet piece 60. The diameter reducer 64 has a double wall construction including an inner wall 66 spaced from an outer wall 68. A cylindrical wall extension 70 is secured to the inner wall 66 of the diameter reducer 46. One end of the wall extension 70 is rolled back to form an annular spacer 72. The aftertreatment device 30 is mounted within the wall extension 70.

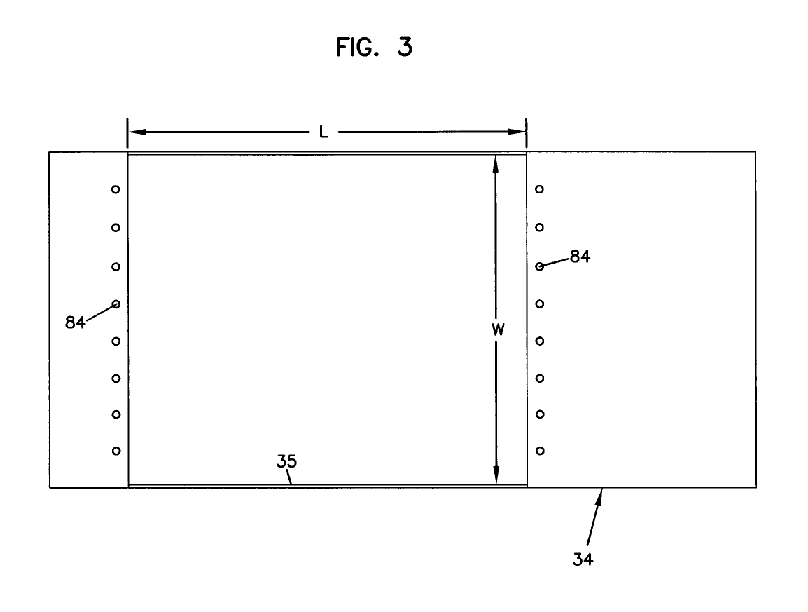

Referring again to FIG. 2, the main body 34 of the component mid-section 26 is generally cylindrical and includes an upstream end 80 and a downstream end 82. The side access opening 35 is defined through the main body 34 at a location between the upstream and downstream ends 80, 82. A plurality of fastener openings 84 (e.g., tapped bolt holes) are provided about the perimeter of the side access opening 35. As shown at FIG. 3, the side access opening 35 preferably has a length L greater than a corresponding length of the aftertreatment device 32, and a width W greater than the diameter of the aftertreatment device 32.

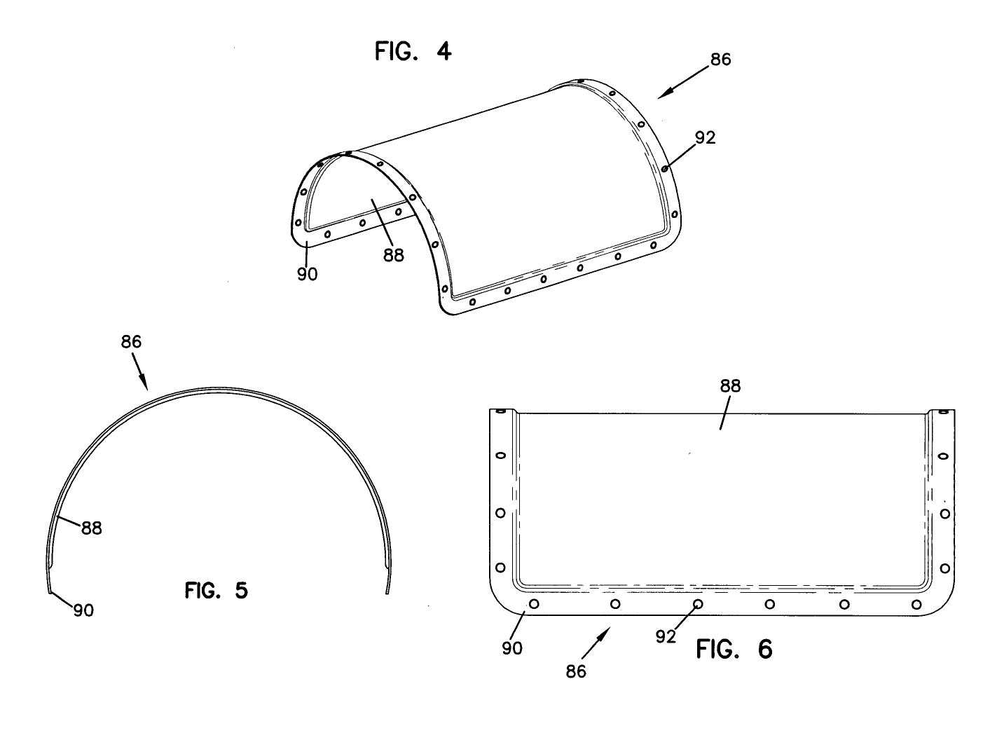

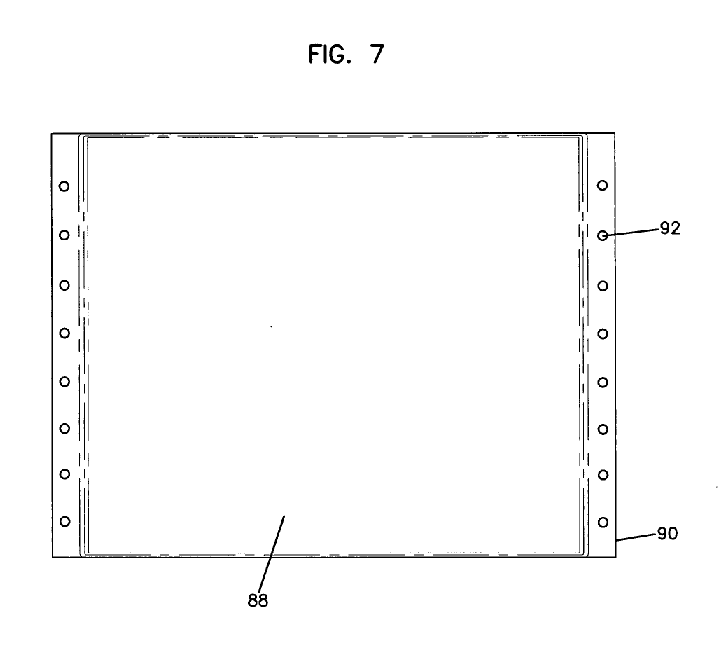

A panel 86 is used to cover the side access opening 35. As shown at FIGS. 4-7, the panel 86 is generally arranged in the shape of a half-cylinder. The panel 86 includes a recessed inner portion 88 surrounded by a raised lip or flange 90 that frames/surrounds the inner portion 88. Fastener openings 92 are defined through the flange 90. When the panel is mounted to the main body 34, the recessed inner portion 88 fits within the side access opening 35 and the raised flange 90 overlaps and seats upon the outer surface of the main body 34. As so positioned, the flange 90 surrounds the perimeter of the opening 35 and the fastener openings 92 defined by the flange 90 align with the fastener openings 84 of the main body 34. Fasteners (e.g., bolts) can be inserted through the openings to secure the panel 86 to the main body 34.

Referring back to FIG. 2, the aftertreatment device 32 includes a substrate 100 mounted within a can 102. A pair of ring baffles 104 are secured to the outside of the can 102. The baffles 104 function to center the aftertreatment device 32 within the main body 34 and to form a seal with the inner surface of the main body 34. In one embodiment, the aftertreatment device 32 is secured to the panel 86 such that the panel 86 and the aftertreatment can be moved together as a unit. The panel 86 can include a handle 87 (schematically shown at FIG. 2) for facilitating handling of the unit. For example, the handle 87 can be grasped to carry the unit to the main body 34 and to position the unit such that the aftertreatment device 32 fits inside the opening 35 and the panel covers the opening 35. The handle 87 also facilitates removing the unit from the main body 34.

To assemble the component 20, the wall extension 50 of the inlet section 22 is inserted in the upstream end 80 of the main body 34 and the wall extension 70 of the outlet section 24 is inserted in the downstream end 82 of the main body 34. As so inserted, the annular spacers 52, 72 frictionally engage the inner surface of the main body 34. To hold the assembly together, the diameter expander 44 is secured to the upstream end of the main body 34 and the diameter reducer 64 is secured to the downstream end of the main body 34. The aftertreatment device 32 is mounted within the main body 34 by inserting the aftertreatment device 32 (which is carried by the panel 86) radially through the side access opening 35 until the panel 86 seats on the exterior of the main body 34. Fasteners are then used to secure the panel 86 in place.

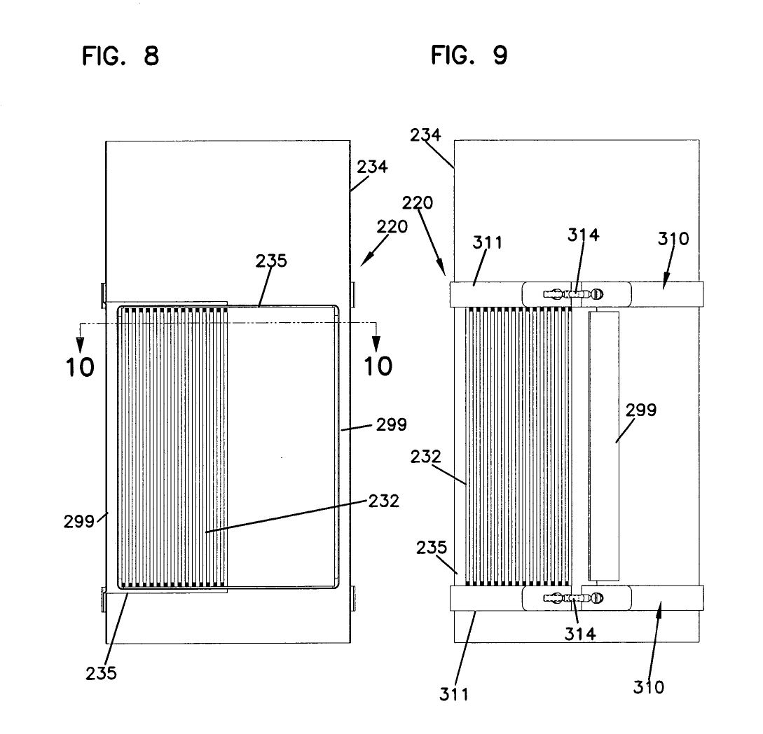

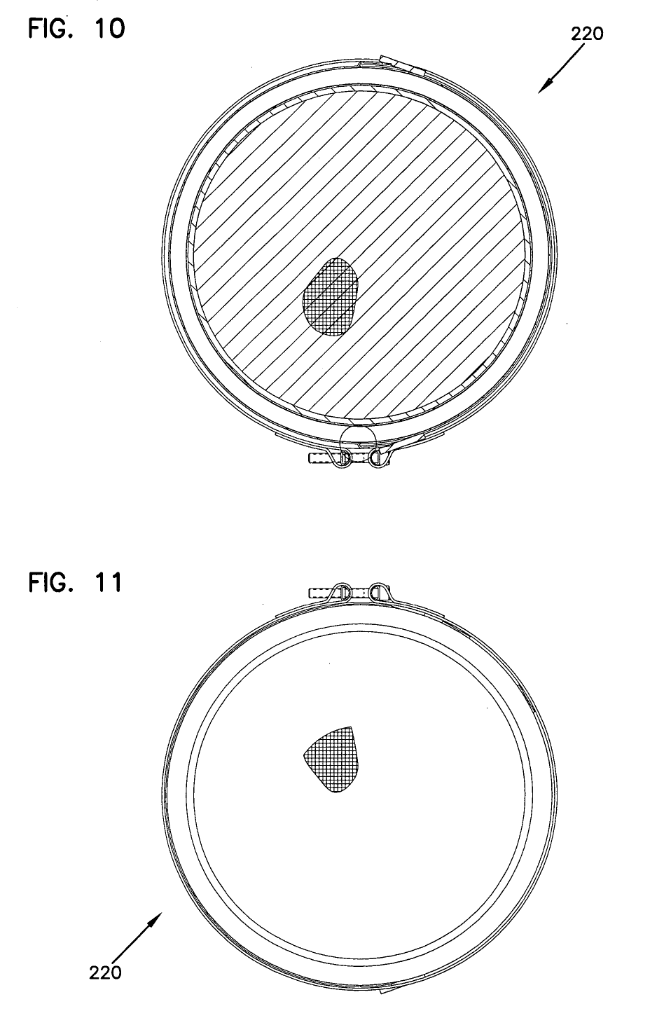

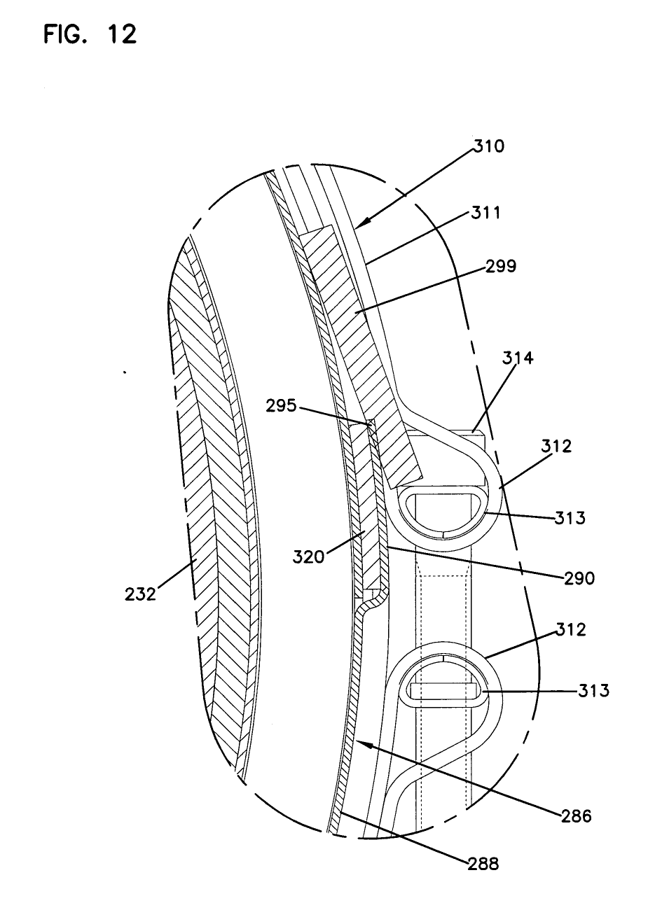

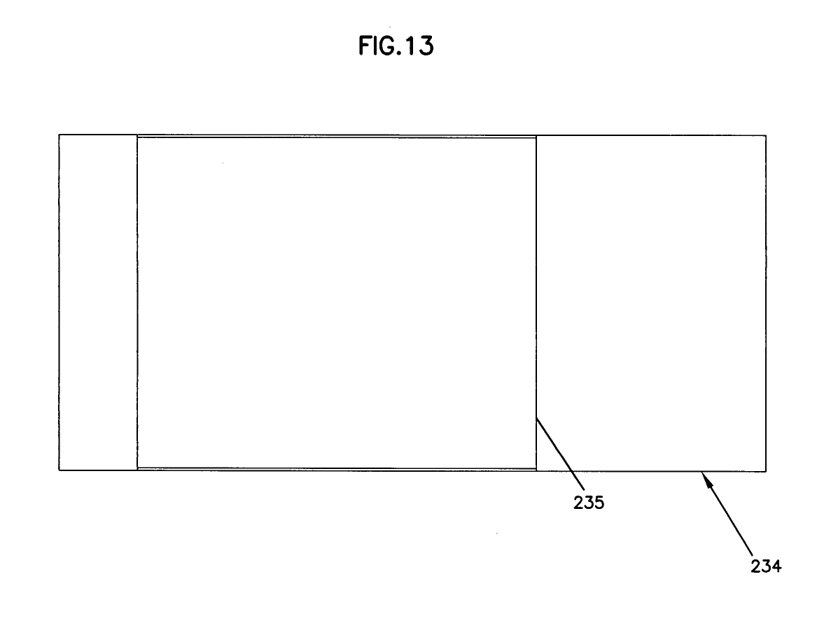

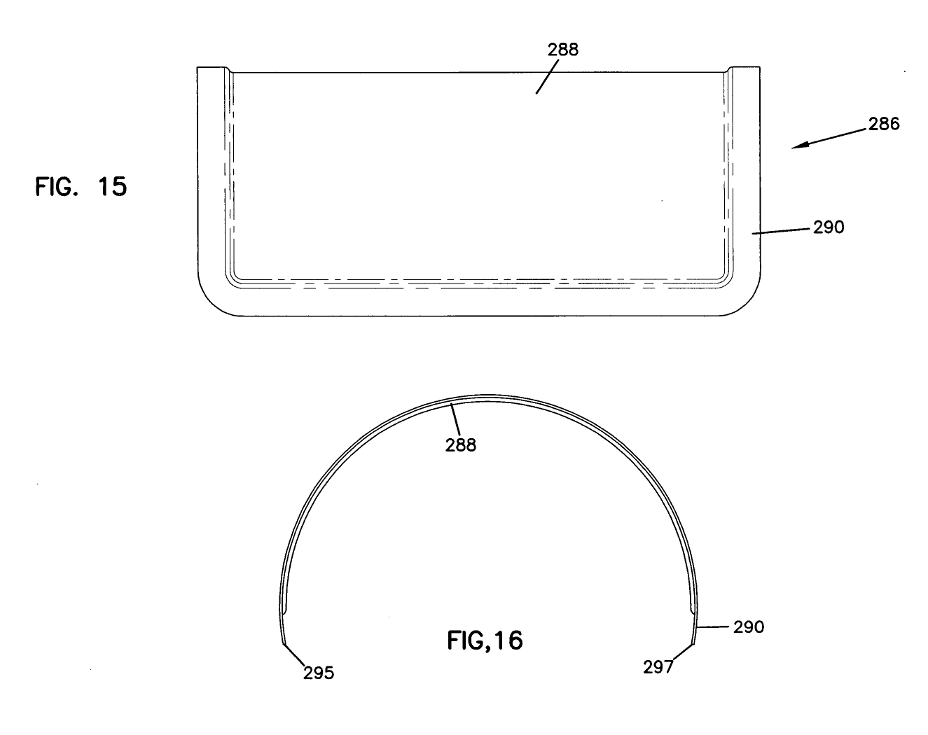

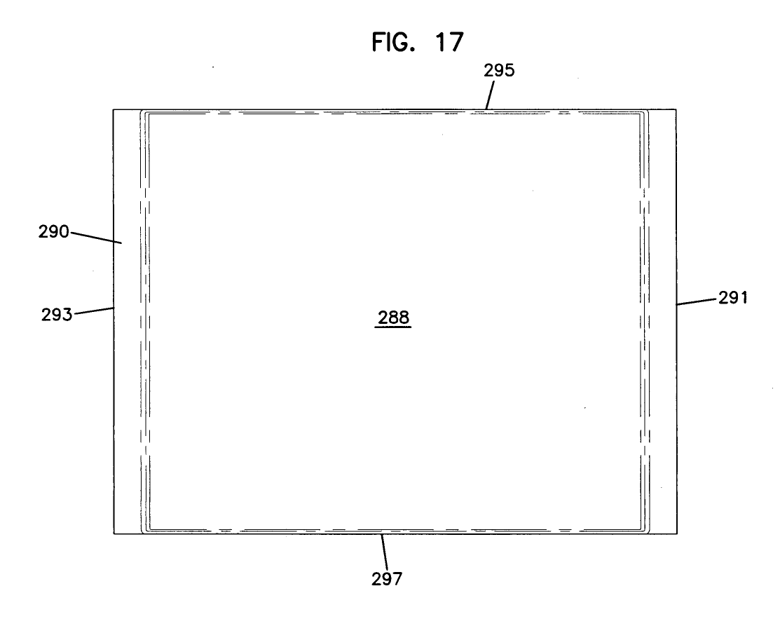

FIGS. 8-13 show another exhaust system component 220 in accordance with the principles of the present disclosure. The component includes a cylindrical housing 234 defining a side access opening 235. The housing 234 can also be referred to as a body, a casing, a canister, a shell or like terms. An aftertreatment device 232 (e.g., a diesel particulate filter) is mounted within the housing 234. The aftertreatment device 232 can be radially inserted into the housing 234 or removed from the housing 234 through the side access opening 235. A panel 286 (shown at FIGS. 12 and 14-17) is used to cover the side access opening 235. In certain embodiments, the panel 286 carries the aftertreatment device 232 such that the panel 286 and the aftertreatment device 232 can be removed together as a unit.

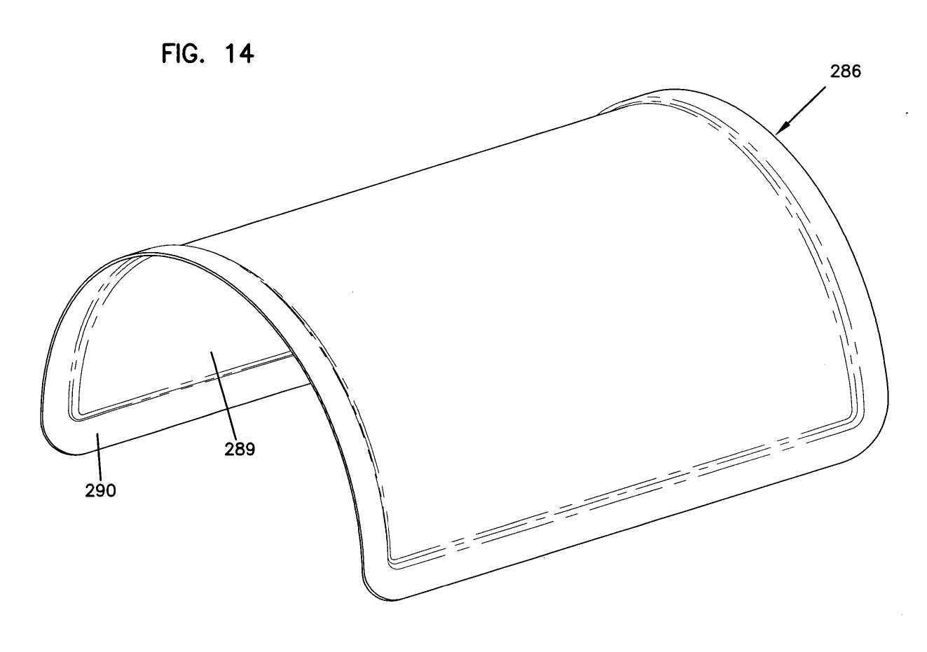

Similar to the panel 86 of FIG. 2, the panel 286 generally forms the shape of a half-cylinder. The panel 286 includes a central recessed region 288 surrounded by a raised lip or flange 290. As shown at FIGS. 14-17, the panel 286 includes first and second opposite sides 291, 293, and third and fourth opposite sides 295, 297 that extend between the first and second sides 291, 293.

Referring to FIG. 9 the panel 286 is secured to the housing 234 by clamps 310. The clamps 310 are preferably strap clamps having bands/straps 311 that wrap around the exterior of the housing 234. Ends 312 of the straps 311 are looped. Trunions 313 are mounted within the looped ends 312 of the straps 311. One or more fasteners 314 (e.g., bolts) extend between the trunions 313 for tightening the clamps 310 by drawing the looped ends 312 toward each other, and for loosening the clamps 310 by moving the looped ends 312 apart from one another.

To secure the panel 286 to the housing 234, the panel 286 is positioned with the recessed region 88 nested within the side access opening 235 and the flange 290 seated on the exterior surface of the housing 234. The straps 311 of the clamps 310 wrap around the housing 234 and are positioned to overlap both the first and second sides 291, 291 of the panel 286 and the exterior surface of the housing 234. When the clamps 310 are tightened, the panel 286 is drawn down against the housing 234. The housing 234 also includes retaining bars 299 under which the third and fourth sides 295, 297 of the panel 286 are received. When the clamps 310 are tightened, the third and fourth sides 295, 297 ride down under the retaining bars 299 (see FIG. 12) to more securely retain the panel 286 in place. By loosening the clamps 310, the panel 286 can be removed to access the aftertreatment device 232.

To improve sealing at the panel 286, a gasket 320 can be mounted between the flange 290 and the outer surface of the housing 234 (see FIG. 12). Example materials for the gasket 320 include fiberglass, ceramic paper, ceramic mat or other materials.

Catalytic converters are commonly used to convert carbon monoxides and hydrocarbons in the exhaust stream into carbon dioxide and water. Diesel particulate filters are used to remove particulate matter (e.g., carbon based particulate matter such as soot) from an exhaust stream. Lean NOx catalysts are catalysts capable of converting NOx to nitrogen and oxygen in an oxygen rich environment with the assistance of low levels of hydrocarbons. For diesel engines, hydrocarbon emissions are too low to provide adequate NOx conversion, thus hydrocarbons are required to be injected into the exhaust stream upstream of the lean NOx catalysts. SCR's are also capable of converting NOx to nitrogen and oxygen. However, in contrast to using HC's for conversion, SCR's use reductants such as urea or ammonia that are injected into the exhaust stream upstream of the SCR's. NOx traps use a material such as barium oxide to absorb NOx during lean burn operating conditions. During fuel rich operations, the NOx is desorbed and converted to nitrogen and oxygen by catalysts (e.g., precious metals) within the traps.

Diesel particulate filter substrates can have a variety of known configurations. An exemplary configuration includes a monolith ceramic substrate having a “honey-comb” configuration of plugged passages as described in U.S. Pat. No. 4,851,015 that is hereby incorporated by reference in its entirety. The substrate is typically housed within a metal can. A mat/mantle material (e.g., an intumescent or non-intumescent mat) is typically provided between the can and the substrate to cushion the substrate, to provide insulation, and to improve retention of the substrate within the can. Wire mesh configurations can also be used. In certain embodiments, the substrate can include a catalyst. Exemplary catalysts include precious metals such as platinum, palladium and rhodium, and other types of components such as base metals or zeolites.

For certain embodiments, diesel particulate filters can have a particulate mass reduction efficiency greater than 7%. In other embodiments, diesel particulate filters can have a particulate mass reduction efficiency greater than 85%. In still other embodiments, diesel particulate filters can have a particulate mass reduction efficiency equal to or greater than 90%. For purposes of this specification, the particulate mass reduction efficiency is determined by subtracting the particulate mass that enters the filter from the particulate mass that exits the filter, and by dividing the difference by the particulate mass that enters the filter.

Catalytic converter substrates can also have a variety of known configurations. Exemplary configurations include substrates defining channels that extend completely therethrough. Exemplary catalytic converter configurations having both corrugated metal and porous ceramic substrates/cores are described in U.S. Pat. No. 5,355,973, that is hereby incorporated by reference in its entirety. The substrates preferably include a catalyst. For example, the substrate can be made of a catalyst, impregnated with a catalyst or coated with a catalyst. Exemplary catalysts include precious metals such as platinum, palladium and rhodium, and other types of components such as base metals or zeolites.

In one non-limiting embodiment, a catalytic converter can have a cell density of at least 200 cells per square inch, or in the range of 200-400 cells per square inch. A preferred catalyst for a catalytic converter is platinum with a loading level greater than 30 grams/cubic foot of substrate. In other embodiments the precious metal loading level is in the range of 30-100 grams/cubic foot of substrate. In certain embodiments, the catalytic converter can be sized such that in use, the catalytic converter has a space velocity (volumetric flow rate through the DOC/volume of DOC) less than 150,000/hour or in the range of 50,000-150,000/hour.

Access panels in accordance with the principles of the present disclosure can be used in exhaust conduits, mufflers or any other exhaust system components adapted to house exhaust aftertreatment devices.

The above specification provides examples of how certain inventive aspects may be put into practice. It will be appreciated that the inventive aspects can be practiced in other ways than those specifically shown and described herein without departing from the spirit and scope of the inventive aspects.

What is claimed is:

1. An exhaust system component comprising:
a body defining an access opening;
an aftertreatment device that mounts within the body, the aftertreatment device being radially removable from the body through the access opening; and
a removable panel that covers the access opening.

2. The exhaust system component of claim 1, wherein the panel is shaped generally in the form of a half-cylinder.

3. The exhaust system component of claim 1 wherein the panel is secured to the body with bolts.

4. The exhaust system component of claim 1, wherein the panel is secured to the body with clamps.

5. The exhaust system of claim 1, wherein the body comprises at least a portion of a muffler body.

6. The exhaust system of claim 1, wherein the panel carries the aftertreatment device.

7. The exhaust system of claim 1, wherein the panel includes a recessed portion that fits within the side access opening and a flange portion that overlaps an exterior surface of the body.

8. The exhaust system of claim 7, wherein the aftertreatment device is secured to the recessed portion of the panel.

9. The exhaust system component of claim 4, wherein the clamps include strap clamps that surround a diameter of the body.

10. The exhaust system component of claim 9, wherein the panel includes first and second opposite sides, and third and opposite fourth sides that extend between the first and second sides, and wherein the clamps overlap the panel at the first and second sides.

11. The exhaust system component of claim 10, wherein the body includes retainers that overlap the panel at the third and fourth sides.
